(19) United States
(12) Patent Application Publication
(10) Pub. No.: US 2014/0196588 A1
(43) Pub. Date: Jul. 17, 2014

(54) CYMBAL ASSEMBLY AND METHOD TO PRODUCE A MULTIPLICITY OF SOUNDS

(71) Applicant: Akito TAKEGAWA, Chiba (JP)

(72) Inventor: Akito TAKEGAWA, Chiba (JP)

(73) Assignee: PEARL MUSICAL INSTRUMENT CO.,, Chiba (JP)

(21) Appl. No.: 13/740,851

(22) Filed: Jan. 14, 2013

(51) Int. Cl. G10D 13/06

(52) U.S. Cl. CPC G10D 13/06
USPC 84/422.1

(57) ABSTRACT

A mounting assembly with different washer assemblies for a cymbal has a stand rod, an adjusting rod, an inner fastener, an outer fastener, an inner composite washer assembly and an outer composite washer assembly. The adjusting rod is mounted pivotally on the stand rod. The inner and outer fasteners are mounted securely on the adjusting rod. The inner and outer composite washer assemblies are mounted around the adjusting rod and are mounted between the inner and outer fasteners. The cymbal is mounted around the adjusting rod and is clamped between the inner and outer composite washer assemblies. Each washer assembly has a relative hard surface and soft surface as well as different diameters to provide a multiplicity of sounds available to the percussionist.

### BACKGROUND OF THE INVENTION

1. Field of the Invention

The present invention relates to a holding device for a cymbal and especially to a mounting system with two different washer assemblies for a cymbal.

2. Description of Related Art

Cymbals are part of standard drum kits. The cymbals are held on mounting assemblies that mount or hold the cymbals at a certain height that is easy for the user to drum. The conventional mounting assembly comprises a stand rod, an adjusting rod, two washers and two fasteners. The adjusting rod is mounted pivotally on the stand rod. The cymbal is mounted around the adjusting rod. The washers are mounted around the adjusting rod and are adjacent respectively to the two sides of the cymbal. The fasteners are mounted on the adjusting rod. The washers and the cymbal are clamped between the two fasteners. The washers are used to absorb shocks when the cymbal is drummed. Because the shock-absorbing effects provided by washers made of different materials are different, sounds given off by a cymbal with different washers are different. Conventional washers are always made of felt or rubber. The shock-absorbing effect of washers made of felt is relatively large so that the sound given off by the cymbal is mellow and lasts shorter. The shock-absorbing effect of washers made of rubber is relatively small so that the sound given off by the cymbal is bright and clear and lasts longer. Therefore, different washers are necessary to fit with needs of different drummers having different performing habits or for performing different styles of music.

As shown in FIG. 1, the present cymbal stands generally utilized throughout the music industry employ a cymbal rod 3 at their upper extremity. The top portion of this cymbal rod is usually threaded to receive the wing nut 2. There is typically an oversized stop (not shown) at the base of the rod over which is fitted a curved metal washer 5. A felt washer 4 usually rests on the metal washer 5 and the cymbal rod 3 is usually covered by a plastic sleeve. The cymbal 1 fits over the rod and the sleeve by virtue of a center hole in the cymbal 1. Finally, a wing nut 2 is tightened onto the top, threaded portion of the rod in order to keep the cymbal 1 from coming off the rod. A tilting mechanism or elbow 8 may be used to tilt the cymbal as desired by the percussionist.

Because the aforementioned two different conventional washers provide two extreme sounds, the percussionist is limited in the types of sounds that can be generated and has to change the washers to fit with different styles of music. Furthermore, most music does not need such an extreme sound. Therefore, using either kind of conventional washers cannot provide a moderate sound to fit with most music. Additionally, the ability to control the amount of sustain and choke of the cymbals is very limited.

To overcome the shortcomings, the present invention provides a mounting assembly with different washer assemblies for a cymbal to mitigate or obviate the aforementioned problems.

### SUMMARY OF THE INVENTION

An objective of the present invention is to provide a holding device with composite washer assemblies for a cymbal to give off moderate sound. The holding device with composite washer assemblies for a cymbal has a stand rod, an adjusting rod, an inner fastener, an outer fastener, an inner composite washer assembly and an outer composite washer assembly. The adjusting rod is mounted pivotally on the stand rod, The inner and outer fasteners are mounted securely on the adjusting rod. The inner and outer composite washer assemblies are mounted around the adjusting rod and are mounted between the inner and outer fasteners. The cymbal is mounted around the adjusting rod and is clamped between the inner and outer composite washer assemblies. Each washer assembly has a hard face, a soft face, and a set of washers has a different diameter which allow them to be arranged in a variety of ways to generate different sounds as desired by the percussionist.

More specifically, the present invention provides a cymbal assembly comprising a support rod for supporting a cymbal at a predetermined height. The cymbal is mounted on a support rod by first and second washer assemblies, wherein the first washer assembly has a diameter that is different than the second washer assembly to improve a percussionist's control over the amount of sustain and choke of the cymbal assembly. The cymbal is sandwiched between the first and second washer assemblies to retain said cymbal on said support rod.

In one preferred embodiment, the first washer assembly has a first felt surface and a first foam surface having a different hardness than the first felt surface, wherein the first soft (felt) surface is disposed opposite to the first hard (foam) surface. Likewise, the second washer assembly has a second felt surface and a second foam hard surface having a different hardness than the second soft surface, wherein said second soft (felt) surface is disposed opposite to the second hard (foam) surface. The foam surface may include neoprene and/or urethane.

Other objectives, advantages and navel features of the invention will become more apparent from the following detailed description when taken in conjunction with the accompanying drawings.

### BRIEF DESCRIPTION OF THE DRAWINGS

FIG. 1 is a broken perspective view of a conventional cymbal mounting assembly;

FIG. 2 is a side view of a first embodiment of the mounting assembly in accordance with the present invention;

FIG. 3 is a side view of a second embodiment of the mounting assembly in accordance with the present invention;

FIG. 4 is a side view of a third embodiment of the mounting assembly in accordance with the present invention;

FIG. 5 is a side view of a fourth embodiment of the mounting assembly in accordance with the present invention;

FIG. 6 is a side view of a fifth embodiment of the mounting assembly in accordance with the present invention;

FIG. 7 is a side view of a sixth embodiment of the mounting assembly in accordance with the present invention;

FIG. 8 is a side view of a seventh embodiment of the mounting assembly in accordance with the present invention;

FIG. 9 is a side view of an eight embodiment of the mounting assembly in accordance with the present invention.

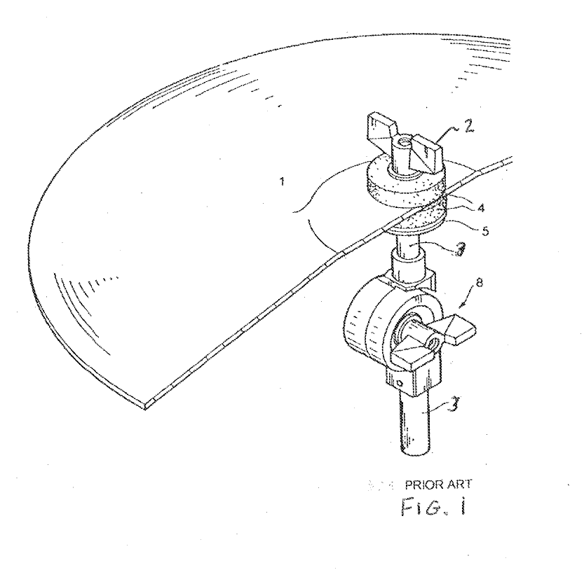

### DETAILED DESCRIPTION OF THE PREFERRED EMBODIMENTS

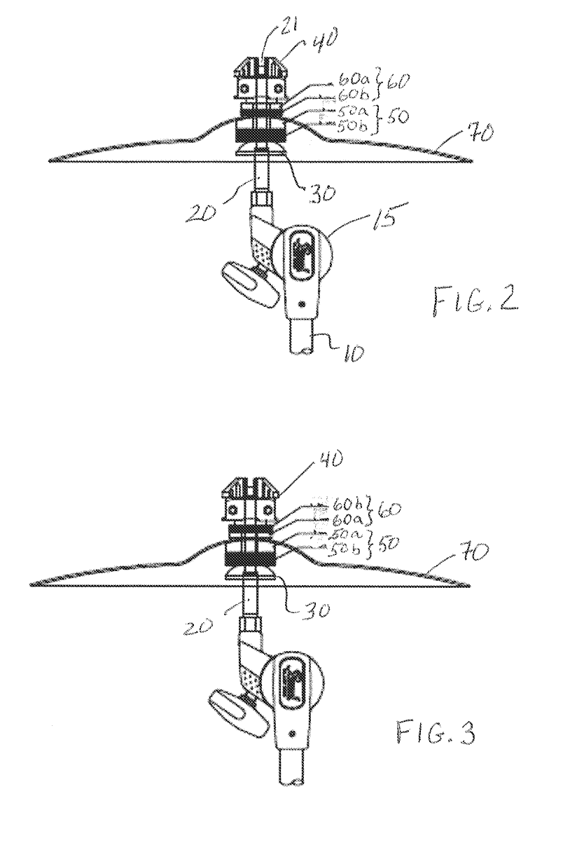

With reference to FIGS. 2-9, a mounting assembly with different washer assemblies for a cymbal in accordance with the present invention comprises a stand rod 10, an adjusting rod 20, an inner fastener 0, an outer fastener 40, an inner washer assembly 50, and an outer washer assembly 60.

The adjusting rod 20 is mounted pivotally on the stand rod 10 via the pivoting mechanism or elbow 15. The adjusting rod 20 has a pivoting end and a threaded end 21. The inner fastener 30 is mounted securely on the adjusting rod 20. The outer fastener 40 is screwed on the threaded end 21 of the adjusting rod 20. Alternatively, the outer fastener 40 may be adjustably affixed to the end of adjusting rod by means other than threads.

The inner washer assembly 50 is mounted around the adjusting rod 20, is mounted between the inner and outer fasteners 30, 40 and is adjacent to the inner fastener 30, The outer washer assembly 60 is mounted around the adjusting rod 20, is mounted between the inner and outer fasteners 30, 40 and is adjacent to the outer fastener 40. The cymbal 70 is mounted around the adjusting rod 20 and is clamped by the inner and outer washer assemblies 50, 60.

Each inner and outer washer assembly 50, 60 is preferably defined by a two-sided washer that is a combination of a soft surface; e.g. a felt material 50a, 60a and relatively hard surface; i.e., a foam material 50b, 60b. However, the invention may comprise washer assemblies 50, 60 having multiple pieces that are not formed as a single unit. Additionally, one of the inner and outer washer assemblies 50, 60 is larger in diameter than the other, and the washer assemblies 50, 60 may be switched as shown in FIGS. 2-9 to increase the multiplicity of possible sounds achieved by the percussionist. The use of different diameter washer assemblies 50, 60 permits improved control over the amount of sustain and choke of the cymbals when compared to similar washers having a uniform size. FIGS. 2-5 show embodiments where the outer washer assembly 60 has a smaller diameter than the inner washer assembly 50. FIGS. 6-9 show embodiments where the inner washer assembly 50 has a smaller diameter than the outer washer assembly 60.

The first embodiment of the mounting assembly is shown in FIG. 2. The hard surface 50b of the inner washer assembly 50 is adjacent to the inner fastener 30. The soft surface 50a of the inner washer assembly 50 is adjacent to the cymbal 70. The soft surface 60a of the outer washer assembly 60 is adjacent to the outer fastener 40. The hard surface 60b of the outer washer assembly 60 is adjacent to the cymbal 70. Additionally, the outer washer assembly 60 has a smaller diameter than the inner washer assembly 50.

The second embodiment of the mounting assembly is shown in FIG. 3. The hard surface 50b of the inner washer assembly 50 is adjacent to the inner fastener 30. The soft surface 50a of the inner washer assembly 50 is adjacent to the cymbal 70. The hard surface 60b of the outer washer assembly 60 is adjacent to the outer fastener 40. The soft surface 60a of the outer washer assembly 60 is adjacent to the cymbal 70. Additionally, the outer washer assembly 60 has a smaller diameter than the inner washer assembly 50.

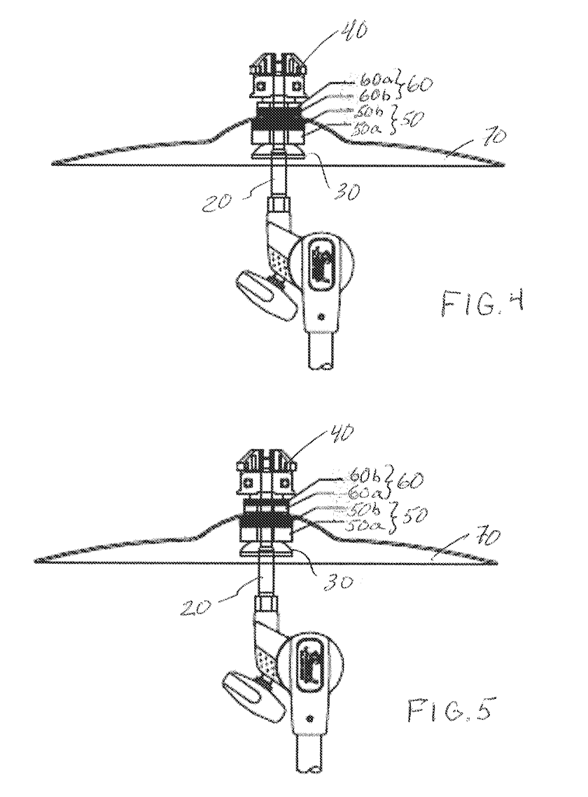

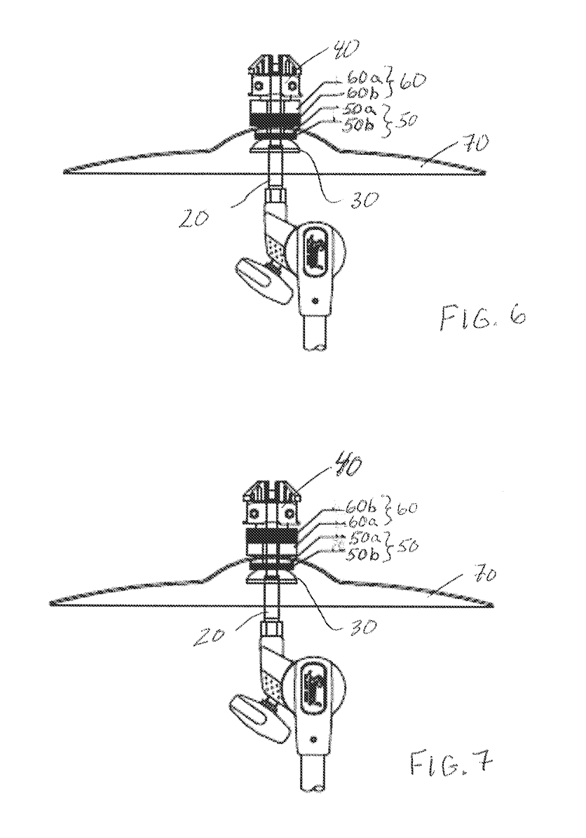

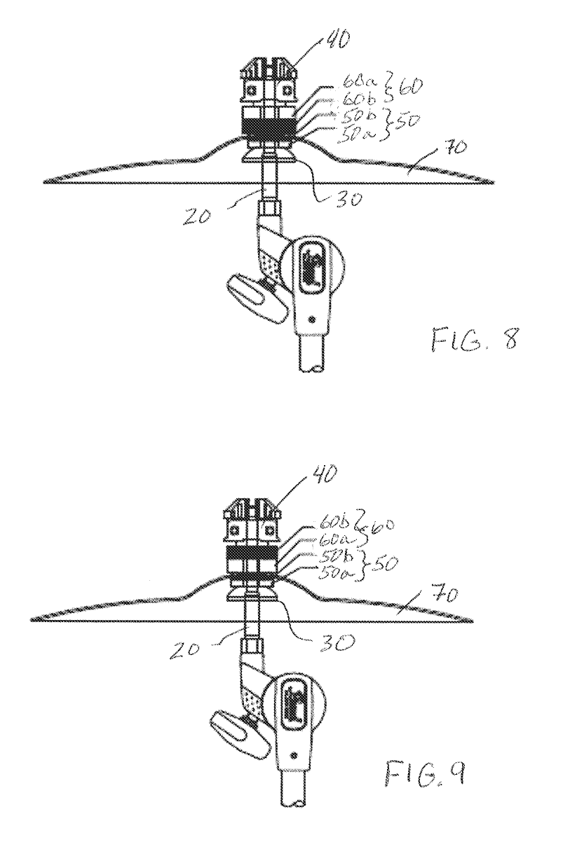

The third embodiment of the mounting assembly is shown in FIG. 4. The soft surface 50a of the inner washer assembly 50 is adjacent to the inner fastener 30. The hard surface 50b of the inner washer assembly 50 is adjacent to the cymbal 70. The hard surface 60b of the outer washer assembly 60 is adjacent to the cymbal 70. The soft surface 60a of the outer washer assembly 60 is adjacent to the outer fastener 40. Additionally, the outer washer assembly 60 has a smaller diameter than the inner washer assembly 50.

The fourth embodiment of the mounting assembly is shown in FIG. 5. The soft surface 50a of the inner washer assembly 50 is adjacent to the inner fastener 30. The hard surface 50b of the inner washer assembly 50 is adjacent to the cymbal 70. The soft surface 60a of the outer washer assembly 60 is adjacent to the cymbal 70. The hard surface 60b of the outer washer assembly 60 is adjacent to the outer fastener 40. Additionally, the outer washer assembly 60 has a smaller diameter than the inner washer assembly 50.

The fifth embodiment of the mounting assembly is shown in FIG. 6. The hard surface 50b of the inner washer assembly 50 is adjacent to the inner fastener 30. The soft surface 50a of the inner washer assembly 50 is adjacent to the cymbal 70. The hard surface 60b of the outer washer assembly 60 is adjacent to the cymbal 70, The soft surface 60a of the outer washer assembly 60 is adjacent to the outer fastener 40. Additionally, the inner washer assembly 50 has a smaller diameter than the outer washer assembly 60.

The sixth embodiment of the mounting assembly is shown in FIG. 7. The hard surface 50b of the inner washer assembly 50 is adjacent to the inner fastener 30, The soft surface 50a of the inner washer assembly 50 is adjacent to the cymbal 70. The soft surface 60a of the outer washer assembly 60 is adjacent to the cymbal 70. The hard surface 60b of the outer washer assembly 60 is adjacent to the outer fastener 40. Additionally, the inner washer assembly 50 has a smaller diameter than the outer washer assembly 60.

The seventh embodiment of the mounting assembly is shown in FIG. 8. The soft surface 50a of the inner washer assembly 50 is adjacent to the inner fastener 30. The hard surface 50b of the inner washer assembly 50 is adjacent to the cymbal 70, The hard surface 60b of the outer washer assembly 60 is adjacent to the cymbal 70. The soft surface 60a of the outer washer assembly 60 is adjacent to the outer fastener 40. Additionally, the inner washer assembly 50 has a smaller diameter than the outer washer assembly 60.

The eighth embodiment of the mounting assembly is shown in FIG. 9, The soft surface 50a of the inner washer assembly 50 is adjacent to the inner fastener 30, The hard surface 50b of the inner washer assembly 50 is adjacent to the cymbal 70. The soft surface 60a of the outer washer assembly 60 is adjacent to the cymbal 70, The hard surface 60b of the outer washer assembly 60 is adjacent to the outer fastener 40. Additionally, the inner washer assembly 50 has a smaller diameter than the outer washer assembly 60.

The cymbal assembly according to the present invention provides a new and novel set of washer configurations to allow a multiplicity of sounds from cymbals by mixing and matching the orientation of washers having different materials and sizes. The assembly consists of two felt washers each having a soft layer and a hard layer. The soft layer is the felt itself and the hard layer is a different hardness of felt or an entirely different material that is adhered to the soft layer. For example, one felt may be thinner that the other. These different washers are disposed in different orientations and positions where each position produces a different sound from a cymbal in unpredictable ways. By experimenting, the percussionist can find the washer combination that produces the most pleasing sound or most unusual effect.

Additionally, the use of different sized washers permits improved control over the amount of sustain and choke of the cymbals when compared to similar washers having a uniform size.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A cymbal assembly, comprising:
a support rod for supporting a cymbal at a predetermined height;
a cymbal mounted on said support rod;
a first washer assembly having a first soft surface and a first hard surface having a different hardness than said first soft surface, said first soft surface being disposed opposite to said first hard surface;
a second washer assembly having a second soft surface and a second first hard surface having a different hardness than said second soft surface, said second soft surface being disposed opposite to said second hard surface;
said first washer assembly having a diameter that is different than the second washer assembly to improve a percussionist's control over the amount of sustain and choke of the cymbal assembly;
wherein said cymbal is sandwiched between said first and second washer assemblies to retain said cymbal on said support rod.

2. The cymbal assembly according to claim 1, wherein said first and second soft surfaces include a felt material.

3. The cymbal assembly according to claim 1, wherein said first and second hard surfaces include a foam material.

4. The cymbal assembly according to claim 3, wherein said foam material includes at least one of urethane and neoprene.

5. The cymbal assembly according to claim 1, wherein each of the first and second washer assemblies are unitary members having both the soft and hard surfaces.

6. The cymbal assembly according to claim 1, further comprising a threaded fastener to retain said first and second washer assemblies and said cymbal on said support rod.

7. A cymbal assembly, comprising:
a support rod for supporting a cymbal at a predetermined height;
a cymbal mounted on said support rod;
a first washer assembly having a first opposite surfaces adapted to engage said cymbal;
a second washer assembly having a second opposite surfaces adapted to engage said cymbal;
said first washer assembly having a diameter that is different than the second washer assembly to improve a percussionist's control over the amount of sustain and choke of the cymbal assembly,
wherein said cymbal is sandwiched between said first and second washer assemblies to retain said cymbal on said support rod.

8. The cymbal assembly according to claim 7, wherein said first washer assembly has a first felt surface and a first foam surface having a different hardness than said first felt surface, said first soft surface being disposed opposite to said first hard surface.

9. The cymbal assembly according to claim 7, wherein said second washer assembly having a second felt surface and a second foam hard surface having a different hardness than said second soft surface, said second soft surface being disposed opposite to said second hard surface.

10. The cymbal assembly according to claim 8, wherein said foam surface includes at least one of neoprene and urethane.

11. The cymbal assembly according to claim 9, wherein said foam surface includes at least one of neoprene and urethane.

12. The cymbal assembly according to claim 7, wherein each of the first and second washer assemblies are unitary members having both the felt and foam surfaces.

13. The cymbal assembly according to claim 7, further comprising a threaded fastener to retain said first and second washer assemblies and said cymbal on said support rod.
